(19) United States
(12) Patent Application Publication
(10) Pub. No.: US 2006/0266809 A1
(43) Pub. Date: Nov. 30, 2006

(54) Mailing device and method of use

(76) Inventors: Andrew Gordon Wert, Avon, CT (US); Margaret Johanna Wert, Avon, CT (US)

Correspondence Address: WHITE-WELKER & WELKER, LLC, P.O. BOX 199, CLEAR SPRING, MD, 21722-0199, US

(21) Appl. No.: 11/443,944

(22) Filed: May 31, 2006

Related U.S. Application Data
(60) Provisional application No. 60/685,570, filed on May 31, 2005.

(51) Int. Cl. B42D 15/00; B65D 27/04; B65D 27/00

(52) U.S. Cl. 229/92.8; 229/71; 229/92.3

(57) ABSTRACT

The mailing device of the present invention consists of a rectangular card having front and back surfaces. The front and back surfaces are divided into three corresponding sections; the front surface having a first, second, and third sections; and the back surface having fourth, fifth and sixth sections. The first section corresponds to the fourth section; the second section corresponds to the fifth section and the said third section corresponds to the sixth section. The sections are defined by flexible spins as means for folding the sections together into a flat orientation and, when folded, the front surfaces define the interior of the folded mailer and the back surfaces define the exterior of the mailer. The first section contains mailer contents while the second section defines an interior center. The third section defines an interior side and contains information while the fourth section defines an exterior back surface when folded providing an area for postage and messages. The fifth section which the exterior center and front when folded; and the sixth section defines an interior surface when folded and contains information.

### CROSS REFERENCE TO RELATED APPLICATIONS

This application claims priority from U.S. Provisional Patent Application Ser. No. 60/685,570, entitled “Post Card Mailer Box”, filed on May 31, 2005.

### FEDERALLY SPONSORED RESEARCH

Not Applicable

### SEQUENCE LISTING OR PROGRAM

Not Applicable

### TECHNICAL FIELD OF THE INVENTION

The present invention relates generally to postcards. More specifically, the present invention relates to an educational postcard with display areas that is constructs of multiple panels which can securely display contents without a protruding surface.

### BACKGROUND OF THE INVENTION

The broad concept of post card mailers comprised of see through windows and content areas on the front and back external surfaces is well established in the prior art. See U.S. Pat. No. 3,266,714 filed in 1964. Many improvements to this simple device have occurred which include the use of adhesives (U.S. Pat. No. 4,807,807) and other embodiments for providing shipping and display means for photographs (U.S. Pat. No. 4,079,881 and U.S. Pat. No. 5,788,144).

The prior art noted herein suffers from many shortcomings. For example, the prior art does not teach use for providing additional surfaces in a multi-folding format for the inclusion of additional information on additional interior and exterior surfaces or sections.

More specifically, U.S. Pat. No. 3,266,714 teaches a postcard constructed for mailing photos and “similar” articles that are essentially so thin that they can be considered two-dimensional. It is therefore an objective of the present invention to teach a mailing device that provides for securing “dimensional” contents that are not flat.

U.S. Pat. No. 4,237,633 issued to Murrell in 1980 and now expired teaches a basic folding mailing postcard. This postcard provides for five segments that may contain themed content, messages, mailing addressed, and a window for viewing content place on one segment that comprises and interior portion when folded flat.

U.S. Pat. No. 6,024,278 issued to Martin, teaches and illustrates a multi-foldable, collapsible mailing article. Martin's mailing article suffers from many shortcoming since it provides for no advertising means or content, is not foldable or expandable to accommodate various sized content, and it for mailing collectibles only.

U.S. Pat. No. 6,189,774 issued to Pearson and U.S. Pat. No. 6,807,761 issued to Rappaport, et al. both disclosed a bi-mailing postcard for use as picture frames. Pearson incorporates a bi-fold design for securing the picture within the postcard and provides for a window and a slot while Rappaport, et al. uses a multi-layer composition and side-loading slot. Both incorporate a triangular shaped element for supporting the postcard in an upright position. While both teach the folding and window elements of the present invention, neither disclose a tri-fold, or multi-fold design as utilized by the present invention.

One shortcoming of the mailing devices of the prior art is that they are designed only to secure contents that are flat or dimensionless. The mailing devices of the prior art can not accommodate contents which are dimensional, having some thickness, width, and height, that must requires more than a flat postcard mailer with a minimal thickness, essentially eliminating a dimension.

Another shortcoming of the mailing devices of the prior art is that to accommodate dimensional contents they must often have protruding display areas which may result in damage during shipment when, these irregular shaped mailers are sort or package for transport.

Yet another shortcoming is that they have no provision for supporting structures that can prevent the mailer itself and its contents from being crushed.

### SUMMARY OF THE INVENTION

The present invention is a multi-paneled postcard constructed such that it can securely display dimensional contents without a protruding display area. Construction of the multi-paneled postcard includes supporting structures to prevent the mailing device from being crushed when mailed. It is intended that a user would purchase the postcard pre-packaged with dimensional contents such as collectibles, magnets, trading cards, stickers, games, electronics, CD/DVDs or other pre-recorded media and write a personalized message on the mailing device before mailing it to a recipient.

The mailing device of the present invention consists of a rectangular card having front and back surfaces. The front and back surfaces are divided into three corresponding sections; the front surface having a first, second, and third sections; and the back surface having fourth, fifth and sixth sections. The first section corresponds to the fourth section; the second section corresponds to the fifth section and the said third section corresponds to the sixth section. The sections are defined by flexible spins as means for folding the sections together into a flat orientation and, when folded, the front surfaces define the interior of the folded mailer and the back surfaces define the exterior of the mailer.

The first section contains mailer contents while the second section defines an interior center. The third section defines an interior side and contains information while the fourth section defines an exterior back surface when folded providing an area for postage and messages. The fifth section which the exterior center and front when folded; and the sixth section defines an interior surface when folded and contains information.

It is an objective of the present invention to teach a mailing device consisting of supporting structures that can prevent the mailer itself and its contents from being crushed.

It is therefore another objective of the present invention to teach a mailing device that provides for securing “dimensional” contents that are not flat.

In addition, it is another objective of the present invention to teach a mailing device that does not require protruding areas which securing dimensional contents.

It is also an objective of the present invention to teach a mailing device that is foldable and/or expandable to accommodate various sized content.

It is another objective of the present invention to teach a mailing device with means for sending content, internal messages, and external message such as advertising.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a planar view of the interior sections of a tri-fold embodiment of the mailing device of the present invention;

FIG. 2 is a planar view of the exterior sections of a tri-fold embodiment of the mailing device of the present invention;

FIG. 3 is a perspective view of a tri-fold embodiment of the partially folded mailing device of the present invention;

FIG. 4 is a planar view of the interior sections of a tri-fold embodiment of the mailing device of the present invention;

FIG. 5 is a planar view of the exterior sections of a tri-fold embodiment of the mailing device of the present invention; and

FIG. 6 is a perspective view of a tri-fold embodiment of the partially folded mailing device of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a mailing device.

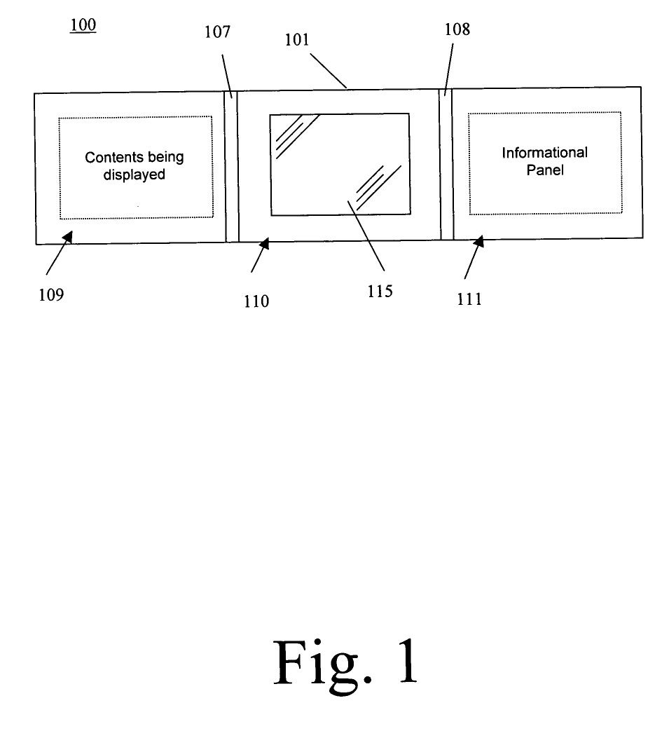

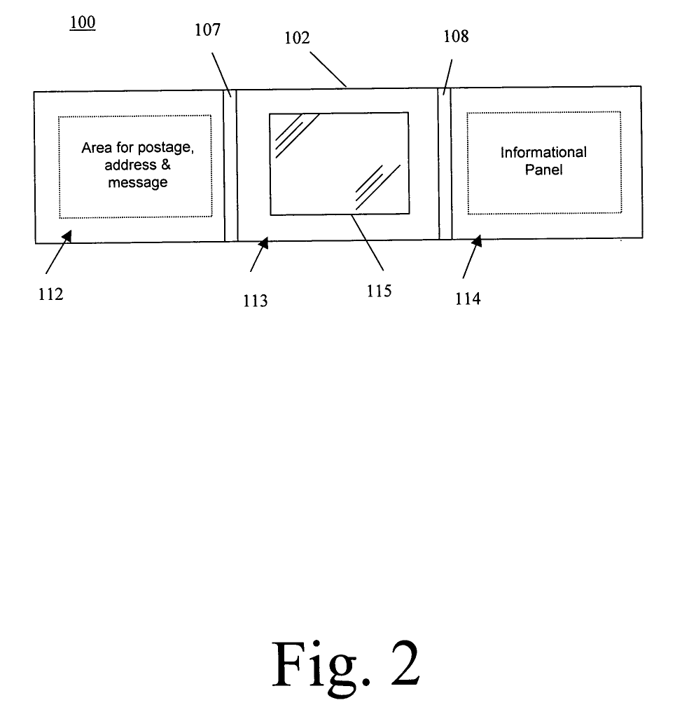

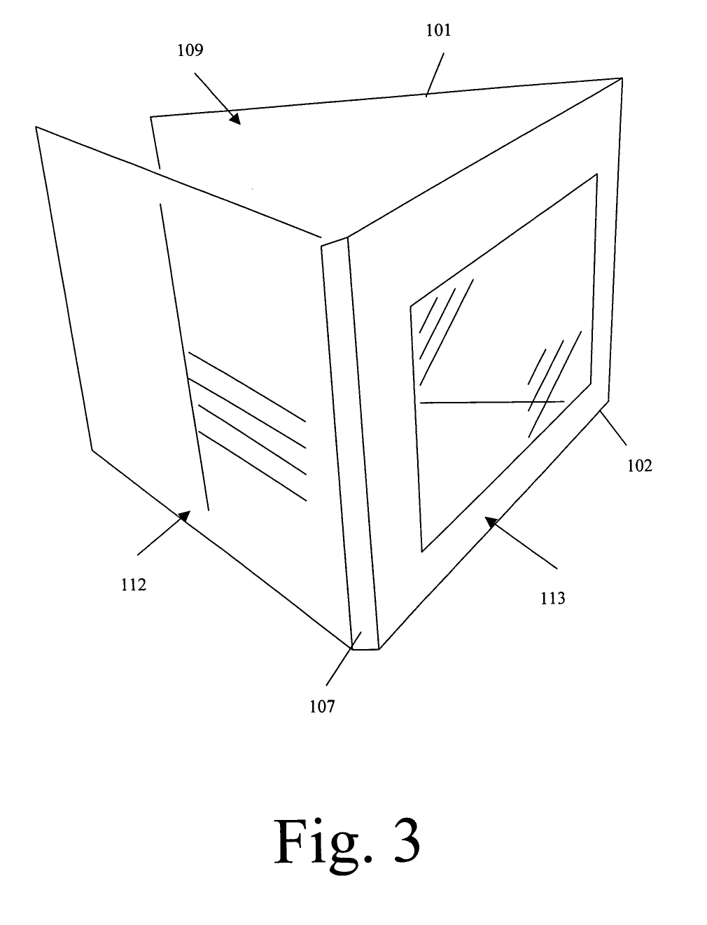

Now referring to FIGS. 1-3, a preferred embodiment of the mailing device is disclosed. The mailing device of the present is comprised of a rectangular card 100 having a front surface 101 and a back surface 102. The front surface 101 and the back surface 102 are each divided into three corresponding sections which can be folded about two lines 107 and 108.

The front surface 101 is comprised of first 109, second 110, and third 111 sections while the back surface 102 is further comprised of fourth 112, fifth 113, and sixth 114 sections. The first section 109 of the front surface 101 corresponds to the fourth section 112 of the back surface 102; the second section 110 of the front surface 101 corresponds to the fifth section 113 of the back surface 102; and the third section 111 of the front surface 101 corresponds to the sixth section 114 of the back surface 102.

The sections are defined by and can be folded about two lines 107 and 108. Flexible spins may be used as means for folding the sections together about two lines 107 and 108 into a flat orientation. When folded, the front surface 102 defines the interior of the folded mailer while the fourth 112 and sixth 114 sections of the back surface 102 define the exterior of the mailer.

With respect to content, the said first section 109 contains internal mailer contents that can be displayed through a window. The second section 110 defines an interior center that may contain a window 115 that allows viewing of the contents on the first section 109, when the mailer is folded closed. The third section 111 defines an interior side and contains information as desired. The fourth section 112 defines an exterior back surface when the mailing device is folded, providing an area for postage and messages. The fifth section 113 defines the exterior center and front when folded. The fifth section 113 may also contain a window 115 that allows viewing of the contents on the first section 109, when the mailer is folded closed. The sixth section 114 defines an interior surface when folded that contains information.

In one embodiment the mailing device is similar to that of a standard post card having a folded or closed dimension of approximately 6 inches high, 8 inches wide, and ⅜ inches deep. When open or unfolded, the mailing device is approximately 6 inches high, 24¾ inches wide, and ⅛ inch deep. When closed or folded, each section lies flat on or below another section. Additionally, to avoid shipping damage, all exterior corners are square and the window 115 is flush. The mailing device 100 and window 115 can be made from any material suitable for mailing that is sturdy enough to withstand multiple mailings through the U.S. Postal System.

The first section 109 defines the interior left panel when the mailing device is folded. The first section 109 should contain mailer contents that would be visible through the window 115 on the front of the folded or closed mailer device. The first section 109 may also be further comprised of a tray or blister pack 116 for securing additional contents. The tray must be able to accommodate a card approximately 7.75×5.75 inches in size, but allow for slight modification on card, to scale, base on packaging requirements. The blister pack must accommodate a card approximately 7.75×5.75 inches in size, but allow for slight modification on card, to scale, base on packaging requirements. The blister bubble 116 should be slightly larger than the window 115 with an inner elevated ridge 117¾ inch from edges on all sides.

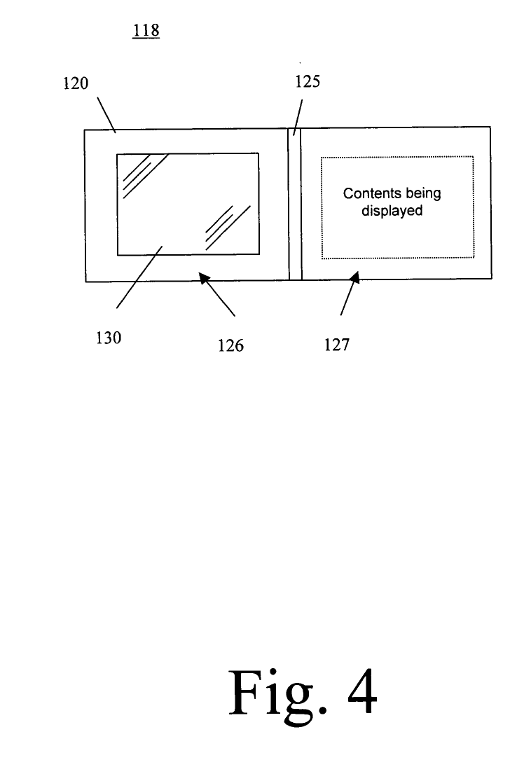

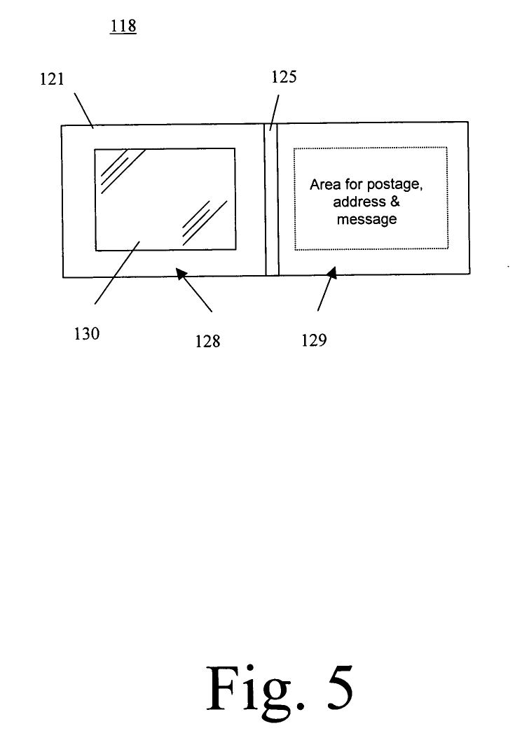

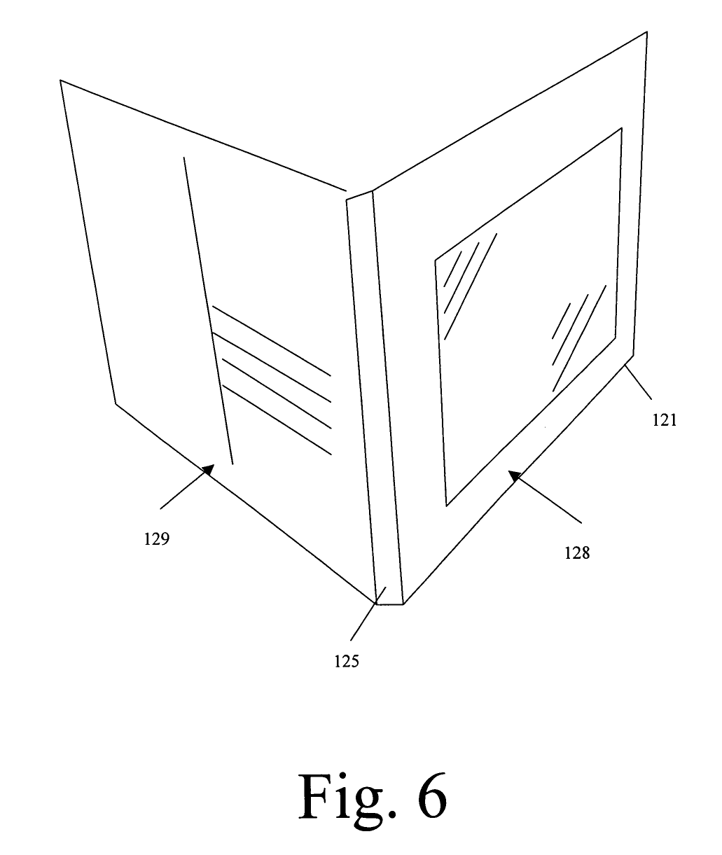

Now referring to FIGS. 4-6, an alternative bi-fold mailing device 118 of the present invention is shown. The bi-fold mailing device 118 of the present is comprised of a rectangular case 119 having a front surface 120 and a back surface 121. The front surface 120 and the back surface 121 are each divided into two corresponding sections that can be folded about one line 125.

The front surface 120 is further comprised of first 126 and second 127 sections while the back surface 121 is further comprised of third 128 and fourth 129 sections. The first section 126 of the front surface 120 corresponds to the third section 128 of the back surface 121; the second section 127 of the front surface 120 corresponds to the fourth section 129 of the back surface 121.

The sections are defined by and can be folded about one line 125. Hinges or other similar rotating means known in the prior art may be used as means for folding the sections together about the line 125 into a flat orientation. When folded, the front surface 120 defines the interior of the folded mailer while the back surface 121 define the exterior of the mailer.

With respect to content, the second section 127 contains internal mailer contents that can be displayed through a window 130. The first section 126 defines an interior center that may contain a window 115 that allows viewing of the contents on the second section 127, when the mailer is folded closed. The third section 128 defines an exterior side that may also contain a window 126 that allows viewing of the contents on the second section 127, when the mailer is folded closed. The fourth section 129 defines an exterior back surface when the mailing device is folded, providing an area for postage and messages.

In one embodiment the bi-fold mailing device is similar to that of a standard CD case. When closed or folded, each section lies flat on or below another section. The bi-fold mailing device 118 and window 126 can be made from any material suitable for mailing that is sturdy enough to withstand multiple mailings through the U.S. Postal System. Typically, a CD case is made from a paper product or plastic, both of which would be suitable for the application of the present invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A mailing device comprising:
a rectangular card having a front and back surfaces;
said front and back surfaces are divided into three corresponding sections;
said front surface having first, second, and third sections;
said back surface having fourth, fifth and sixth sections;
said first section corresponds to said fourth section;
said second section corresponds to said fifth section; and
said third section corresponds to said sixth section.

2. The mailing device of claim 1 wherein said sections are defined by flexible spins as means for folding the sections together into a flat orientation and when folded, said front surfaces define the interior of the folded mailer and said back surfaces define the exterior of the mailer.

3. The mailing device of claim 2 wherein said first section contains mailer contents;
said second section with defines an interior center;
said third section that defines an interior side and contains information;
said fourth section that defines an exterior back surface when folded providing an area for postage and messages;
said fifth section which defines the exterior center and front when folded; and
said sixth section that defines an interior surface when folded and contains information.

4. The mailing device of claim 3 wherein said second section and said fifth section are further comprised of a window which enables the viewing of content provided on the first section when the mailing device is in a folded position.

5. The mailing device of claim 3 wherein said first section further comprises a tray for attaching additional content.

6. The mailing device of claim 3 wherein said first section further comprises a blister pack for attaching additional content.

7. A mailing device comprising:
a rectangular card having a front and back surfaces;
said front and back surfaces are divided into two corresponding sections;
said front surface having first, and second sections;
said back surface having third and fourth sections;
said first section corresponds to said third section;
said second section corresponds to said fourth.

8. The mailing device of claim 7 wherein said sections are attached by a rotating means for folding the sections together into a flat orientation and when folded, said front surfaces define the interior of the folded mailer and said back surfaces define the exterior of the mailer.

9. The mailing device of claim 8 wherein
said first section defines an interior surface and contains information;
said second section defines an interior surface and contains information;
said third section that defines an exterior side and contains information; and
said fourth section that defines an exterior back surface when folded providing an area for postage and messages.

10. The mailing device of claim 9 wherein said second section and said third sections are further comprised of a window which enables the viewing of content provided on the first section when the mailing device is in a folded position.
